(19) United States
(12) Patent Application Publication
(10) Pub. No.: US 2025/0238078 A1
(43) Pub. Date: Jul. 24, 2025

(54) METHOD AND SYSTEM OF GAZE-MAPPING IN REAL-WORLD ENVIRONMENT

(71) Applicant: Pixieray Oy, Espoo (FI)

(72) Inventor: Harri Lehmuskallio, Helsinki (FI)

(73) Assignee: Pixieray Oy, Espoo (FI)

(21) Appl. No.: 18/883,466

(22) Filed: Sep. 12, 2024

(30) Foreign Application Priority Data
Jan. 22, 2024 (FI) 20245061

(51) Int. Cl. G06F 3/01; G06T 7/70

(52) U.S. Cl. CPC G06F 3/013; G06T 7/70

(57) ABSTRACT

A method of gaze-mapping in real-world environments includes determining a first relative pose of an eyewear apparatus with respect to a first camera by processing first image(s) captured by the first camera; determining gaze directions of a user's eyes by processing gaze-tracking data collected by a gaze-tracking means, wherein the gaze-tracking means is arranged in the eyewear apparatus; determining a second relative pose of the user's eyes with respect to a second camera based on the determined first relative pose and a pre-known relative pose of the first camera with respect to the second camera, wherein the second camera is arranged to face a real-world environment; and identifying a gaze-contingent region in second image(s) captured by the second camera.

### TECHNICAL FIELD

The present disclosure relates to methods of gaze-mapping in real-world environments. The present disclosure also relates to systems of gaze-mapping in real-world environments.

### BACKGROUND

In recent years, there has been high advancements in the field of eye-tracking technology, that enables detection and interpretation of eye movements of the user. The eye-tracking technology plays a vital role in diverse fields, such extended-reality (XR) technologies which are being employed in various fields such as entertainment, training, medical imaging operations, navigation, and the like. In human-computer interaction, eye tracking facilitates natural and intuitive control over various aspects of digital interface, such as menu navigation, selection of objects, and the like. Thus, accurate eye tracking is essential for enhancing an overall user experience.

However, existing eye-tracking technology has certain problems associated therewith. Some existing eye-tracking techniques often operate within controlled environments (such as desks with screens or virtual environments) where predetermined knowledge of object locations in relation to the user is utilised for eye tracking purposes. However, such eye-tracking techniques are not suitable and not reliable to be employed in a dynamic real-world environment, where there could be unpredictable lighting conditions, varying user behavior, an absence of predefined knowledge of the object locations, and the like. Moreover, other existing eye-tracking techniques often involves attaching a camera to eye-tracking equipment (such as eye-tracking glasses), for capturing a user's field of view (as the user moves within the real-world environment) followed by a calibration process. Upon said calibration process, a recorded video is matched with recorded eye movements of the user, for determining gaze directions of the user. However, such a calibration process faces challenges when the eye-tacking equipment is not correctly recognized in the recorded video, or when the eye-tacking equipment is temporarily out of a field of view of the camera. Furthermore, such a calibration process is time-consuming, highly unreliable, and do not account for changes in lighting conditions within the real-world environment, changes in user's postures, or similar.

Therefore, in light of the foregoing discussion, there exists a need to overcome the aforementioned drawbacks.

### SUMMARY

The present disclosure seeks to provide a method and a system for identifying gaze-contingent regions in highly realistic and reliable manner, and in computationally-efficient and time-efficient manner. The aim of the present disclosure is achieved by a method and a system which incorporate gaze-mapping in real-world environments, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1A illustrates how at least one first image is captured by a first camera, FIG. 1B illustrates how at least one second image is captured by a second camera, while FIG. 1C illustrates how a gaze-contingent region is identified in the at least one second image, in accordance an embodiment of the present disclosure;

FIG. 2 illustrates a gaze-contingent region in at least one second image of a real-world environment, in accordance with an embodiment of the present disclosure;

FIG. 3 illustrates steps of a method of gaze-mapping in real-world environments, in accordance with an embodiment of the present disclosure; and

FIG. 4 illustrates a block diagram of an architecture of a system of gaze-mapping in real-world environments, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a method comprising:
determining a first relative pose of an eyewear apparatus with respect to a first camera by processing at least one first image captured by the first camera;
determining gaze directions of a user's eyes by processing gaze-tracking data collected by a gaze-tracking means, wherein the gaze-tracking means is arranged in the eyewear apparatus;
determining a second relative pose of the user's eyes with respect to a second camera based on the determined first relative pose and a pre-known relative pose of the first camera with respect to the second camera, wherein the second camera is arranged to face a real-world environment; and
identifying a gaze-contingent region in at least one second image captured by the second camera, based on the determined gaze directions and the determined second relative pose.

In a second aspect, an embodiment of the present disclosure provides a system comprising:
a gaze-tracking means arranged in an eyewear apparatus;
a first camera arranged to face a user;
a second camera arranged to face a real-world environment surrounding the user; and
at least one processor communicably coupled to the gaze-tracking means, the first camera and the second camera, wherein the at least one processor is operable to:
   determine a first relative pose of the eyewear apparatus with respect to the first camera, by processing at least one first image captured by the first camera;
   determine gaze directions of the user's eyes by processing gaze-tracking data collected by the gaze-tracking means;
   determine a second relative pose of the user's eyes with respect to the second camera, based on the determined first relative pose and a pre-known relative pose of the first camera with respect to the second camera; and
   identify a gaze-contingent region in at least one second image captured by the second camera, based on the determined gaze directions and the determined second relative pose.

The present disclosure provides the aforementioned method and the aforementioned system for identifying gaze-contingent regions in highly realistic and reliable manner, and in computationally-efficient and time-efficient manner. Herein, the gaze-contingent region in the at least one second image is identified by mapping the determined gaze directions onto a field of view of the at least one second image from a perspective of the determined second relative pose. The method and the system are susceptible to be used for gaze mapping in static real-world environments as well as dynamic real-world environments, without completely relying on predetermined knowledge of object locations with respect to the user or on any calibration process as in the case of prior art. The method and the system requires minimum equipment for tracking user's gaze as it utilises existing components, for example, such as user's smartphones and eye-tracking glasses, for tracking the user's gaze. This reduces a need for additional hardware and thus it streamlines identification of the gaze-contingent region in a cost-effective manner. The system's ability to continuously monitor and adapt to changes in the user's gaze in real-time ensures its effectiveness in dynamic environments. The method and the system are simple, robust, fast, reliable, support real-time gaze-mapping in real-world environments, and can be implemented with ease.

It will be appreciated that the method enables in determining the gaze directions of the user's eyes and the second relative pose of the user's eyes (with respect to the second camera), for identifying the gaze-contingent region in the at least one second image. The at least one processor of the system is configured to implement the method. Notably, the at least one processor controls an overall operation of the system. The term “gaze-mapping” refers to a process of mapping a user's gaze onto an image of the real-world environment, for identifying a gaze-contingent region (comprising gaze-contingent objects) in said image.

Throughout the present disclosure, the term “eyewear apparatus” refers to an apparatus that is to be worn over the user's eyes. Examples of the eyewear apparatus include, but are not limited to, a pair of glasses, a pair of sunglasses, a pair of smart glasses, and a head-mounted display. The eyewear apparatus may be designed to be comfortably worn by the user for extended periods of time, and may have a frame and lenses, similar to a pair of regular eyeglasses, but with added technological components (for example, such as sensors, cameras or other tracking devices that may be integrated into the frame or the lenses).

Throughout the present disclosure, the term “gaze-tracking means” refers to the specialized equipment for detecting and/or following gaze of the user's eyes, when the eyewear apparatus is in use (namely, is worn by the user). Notably, the gaze-tracking means is arranged in the eyewear apparatus. Optionally, the gaze-tracking means is implemented as one of: contact lenses with sensors, cameras monitoring features of the user's eyes. features of the user's eye, and the like. Such features may comprise at least one of: a shape of a pupil of the user's eyes, a size of the pupil, corneal reflections of at least one light source from a surface of the user's eye, a relative position of the pupil with respect to the corneal reflections, a relative position of the pupil with respect to the corneal reflections, a relative position of the pupil with respect to corners of the user's eye. Such gaze-tracking means are well-known in the art.

It will be appreciated that the gaze-tracking data is collected repeatedly by the gaze-tracking means throughout a given session of using the eyewear apparatus, as gaze of the user's eyes keeps changing whilst he/she uses the eyewear apparatus. Optionally, when processing the gaze-tracking data, the processor is configured to employ at least one of: an image processing algorithm, a feature extraction algorithm, a data processing algorithm. Determining the gaze directions of the user's eyes allows the at least one processor to track where the user is looking/gazing in the real-world environment. Processing the gaze-tracking data to determine the gaze directions is well-known in the art. Optionally, the gaze-tracking data comprises at least one of: images of the user's eyes, videos of the user's eyes, sensor values.

Optionally, a given camera is implemented as a visible-light camera. Examples of the visible-light camera include, but are not limited to, a Red-Green-Blue (RGB) camera, a Red-Green-Blue-Alpha (RGB-A) camera, a Red-Green-Blue-Depth (RGB-D) camera, an event camera, and a monochrome camera. Alternatively, optionally, the given camera is implemented as a combination of a visible-light camera and a depth camera. Examples of the depth camera include, but are not limited to, a Red-Green-Blue-Depth (RGB-D) camera, a ranging camera, a Light Detection and Ranging (LiDAR) camera, a Time-of-Flight (ToF) camera, a Sound Navigation and Ranging (SONAR) camera, a laser rangefinder, a stereo camera, a plenoptic camera, and an infrared (IR) camera. Optionally, the given camera is implemented as a stereo camera. The term “given camera” encompasses at least the first camera and/or the second camera. Moreover, when the depth camera is implemented as a LIDAR camera, it may be used to effectively measure optical distances of objects in the real-world environment up to 5 meters.

Notably, the first camera is arranged in a manner that it faces the eyewear apparatus (namely, the user wearing the eyewear apparatus). Optionally, the at least one first image (captured by the first camera) is a visual representation of at least the eyewear apparatus or its part. On the other hand, the second camera is arranged in a manner that it faces the real-world environment surrounding the user. Optionally, the at least one second image (captured by the second camera) is a visual representation of a real-world scene of the real-world environment being observed by the user. The second camera may be a high-resolution camera to capture the at least one second image with a very high accuracy, thereby allowing for precise visualization of the user's gaze within the real-world scene, as discussed later. The term “visual representation” encompasses colour information represented in a given image, and additionally optionally other attributes (for example, such as depth information, luminance information, transparency information (namely, alpha values), polarization information and the like) associated with the given image.

Optionally, the first camera and the second camera are arranged on opposite sides of a portable device. In this regard, the first camera is arranged on a front side of the portable device, wherein the front side of the portable device faces the eyewear apparatus (namely, the user wearing the eyewear apparatus), whereas the second camera is arranged on a back side (namely, a rear side) of the portable device, wherein the back side of the portable device faces the real-world environment. Optionally, the portable device is a device associated with a user. Examples of the portable device include, but are not limited to, a smartphone, a tablet computer, a laptop computer, a personal digital assistant, a robot, a drone, and a vehicle. In an example, when the portable device is implemented as a smartphone, the first camera may be implemented as a front camera of the smartphone that is typically employed for capturing selfies or taking video calls, whereas the second camera may be implemented as a rear camera of the smartphone that is typically employed to capture images or videos of object(s) present in the real-world environment. A technical benefit of arranging the first camera and the second camera on the portable device is that such an arrangement is easy to implement, can be implemented via existing user devices such as smartphones, and facilitates in simultaneous capturing of the eyewear apparatus and the real-world environment, for enabling accurate identification of the gaze-contingent region in the at least one second image. Moreover, using the portable device, such as a smartphone, may reduce a need for specialised or expensive hardware to be utilised for tracking the user's gaze and for gaze mapping purposes, thereby making the system more accessible and affordable, as compared to solutions that require dedicated devices for the same purposes. Furthermore, since capturing of the eyewear apparatus and the real-world environment is performed simultaneously by utilising the portable device, it may also reduce a latency in identifying the gaze-contingent region in the at least one second image, and may also facilitates in generating a gaze map, which provides information pertaining gaze-contingent regions in a sequence of second images. It will be appreciated that the first camera and the second camera could alternatively be arranged on a non-portable device (namely, a stationary device) in the real-world environment. As an example, a distance between the eyewear apparatus and the portable device may lie in a range of 40-60 centimeters. A lower limit of a distance between the second camera (or the portable device itself) and an object in the real-world environment may lie in a range of 40-60 centimeters.

Notably, the first relative pose of the eyewear apparatus is determined by processing the at least one first image captured by the first camera. The term “pose” refers to a viewing position and/or a viewing orientation. The first relative pose defines a spatial relationship between the eyewear apparatus and the first camera in a three-dimensional (3D) space of the real-world environment. In other words, the first relative pose encompasses both a viewing position and a viewing orientation of the eyewear apparatus with respect to the first camera.

Optionally, the step of determining the first relative pose comprises identifying at least one feature indicative of a pre-known shape of the eyewear apparatus, in the at least one first image, and utilising a pose of the at least one feature as represented in the at least one first image for determining the first relative pose. Optionally, in this regard, the at least one processor is configured to extract a plurality of features in the at least one first image; compare a given feature with the pre-known shape of the eyewear apparatus; and determine a given feature as the at least one feature when the given feature matches the pre-known shape of the eyewear apparatus. Examples of the plurality of features include, but are not limited to, edges, corners, blobs, ridges, high-frequency features, low-frequency features. Optionally, when identifying the at least one feature, the at least one processor is configured to employ at least one image processing algorithm. Such image processing algorithms are well-known in the art. It will be appreciated that information pertaining to the pre-known shape of the eyewear apparatus could be known to the at least one processor from a pre-created 3D model of the eyewear apparatus, a plurality of images of the eyewear apparatus captured from various perspectives, and the like. Since the at least one feature is identified by the at least one processor, the pose of the at least one feature is accurately known to the at least one processor, and thus the first relative pose can be accurately determined. This is because the pose of the at least one feature represented in the at least one first image corresponds to the pose of the eyewear apparatus with respect to the first camera (namely, the first relative pose). It will be appreciated that determining the first relative pose in the aforesaid manner is simple, reliable, and highly accurate.

It will be appreciated that by leveraging the at least one feature of the pre-known shape of the eyewear apparatus, the first relative pose can be determined accurately and precisely. This may be because such a feature-based approach helps in accurately aligning a pose of the eyewear apparatus with a perspective of a pose of the first camera. Moreover, utilising distinct features (such as the at least one feature) indicative of the eyewear apparatus's shape ensures that said relative pose determination is robust against variations in image quality of the at least one first image, lighting conditions in the real-world environment where the eyewear apparatus is present, and the like. Such an approach may, particularly, be useful in dynamic or complex environments where straightforward pose estimation may be challenging. This method reduces the need for extensive calibration processes by using pre-known shapes and features. Since the eyewear apparatus would have well-defined features, the at least one feature can serve as a reliable marker for said relative pose determination. By using utilising the pose of the at least one feature, the first relative pose can be determined in real time or near-real time without requiring any complex computations or extensive data processing.

Optionally, the method further comprises determining a pose of the eyewear apparatus in the real-world environment by processing pose-tracking data, collected by a pose-tracking means arranged in the eyewear apparatus,
wherein the first relative pose is determined based on the pose of the eyewear apparatus in the real-world environment.

Herein, the term “pose-tracking means” refers to specialized equipment that is employed to detect and/or follow a pose of the eyewear apparatus. It will be appreciated that when the eyewear apparatus is worn by the user on his/her head, the pose of the eyewear apparatus changes according to a change in a head pose of the user. Pursuant to embodiments of the present disclosure, the pose-tracking means is implemented as a true six Degrees of Freedom (6DoF) tracking system. In other words, the pose-tracking means tracks both a viewing position and/or a viewing orientation of the eyewear apparatus within a 3D space of the real-world environment. In particular, said pose-tracking means is configured to track translational movements (namely, surge, heave and sway movements) and rotational movements (namely, roll, pitch and yaw movements) of the eyewear apparatus within the 3D space. The pose-tracking means could be implemented as at least one of: an optics-based tracking system (which utilizes, for example, infrared beacons and detectors, infrared cameras, visible-light cameras, and the like), an acoustics-based tracking system, a radio-based tracking system, a magnetism-based tracking system, an accelerometer, a gyroscope, an Inertial Measurement Unit (IMU), a Timing and Inertial Measurement Unit (TIMU). The pose-tracking means are well-known in the art.

Optionally, when determining the pose of the eyewear apparatus, the at least one processor is configured to employ at least one data processing algorithm to process the pose-tracking data. The pose-tracking data may be in the form of images, IMU/TIMU values, motion sensor data values, magnetic field strength values, or similar. Examples of the at least one data processing algorithm include, but are not limited to, a feature detection algorithm, an environment mapping algorithm, and a data extrapolation algorithm. It will be appreciated that the pose-tracking means continuously tracks the pose of the eyewear apparatus throughout a given session of using the eyewear apparatus. In such a case, the at least one processor continuously determines the pose of the eyewear apparatus (in real time or near-real time).

Once the pose of the eyewear apparatus, the at least one processor is optionally configured to determine a distance between the first camera and the eyewear apparatus, for determining the first relative pose.

Optionally, when determining the distance between the first camera and the eyewear apparatus, the at least one processor is configured to process the at least one first image to estimate said distance. This can be done using well-known techniques such as a monocular depth estimation technique, a stereo depth estimation technique, and the like. Alternatively, the at least one processor could also obtain a pose of the first camera from the portable device, and then estimate said distance using the pose of the first camera and the pose of the eyewear apparatus. Optionally, the portable device comprises a pose-tracking means arranged thereat, wherein said pose-tracking means is employed to detect and/or follow a pose of a given camera arranged on the portable device. Such an implementation is beneficial in an instance where the eyewear apparatus is not correctly recognized in the at least one first image, or is out of a field of view of the first camera. Therefore, once the pose of the eyewear apparatus and said distance (namely, an offset between the first camera and the eyewear apparatus) are known, the first relative pose can be easily and accurately determined by the at least one processor. It will be appreciated that determining the first relative pose in the aforesaid manner is simple, reliable, and highly accurate.

It will be appreciated that by using the pose-tracking data collected directly from the eyewear apparatus, a precise determination of a position and an orientation of the eyewear apparatus can be ensured. Processing the pose-tracking data in real-time allows the system to adapt quickly to changes in the pose of the eyewear apparatus. This is particularly beneficial in dynamic environments where the user's movements might be frequent or unpredictable. Arranging the pose-tracking means into the eyewear apparatus minimises a need for additional external tracking devices. A use of the pose-tracking data for determining the first relative pose helps maintain consistency and reliability in pose estimation across various real-world scenarios. Such a consistency is crucial for subsequently determining the second relative pose of the user's eyes with respect to the second camera.

Notably, once the first relative pose is determined, the second relative pose of the user's eyes with respect to the second camera is determined. In this regard, information pertaining to the pre-known relative pose of the first camera with respect to the second camera could be obtained by the at least one processor from the portable device (or from the pose-tracking means of the portable device), the at least one processor being communicably coupled to the portable device. It is to be understood that the pre-known relative pose is indicative of an offset (namely, a distance) between the first camera and the second camera. Said offset would be generally fixed (namely, constant) as the first camera and the second camera are optionally arranged on the portable device (in a fixed manner). Therefore, once the first relative pose (i.e., how the eyewear apparatus being worn by the user is arranged with respect to the first camera) and the pre-known relative pose (i.e., how the second camera is arranged with respect to the first camera) are known, and it is understood that the eyewear apparatus is in use, the second relative pose (i.e., how the user's eyes are arranged with respect to the second camera) can be easily and accurately determined by the at least one processor.

Further, once the gaze directions of the user's eyes and the second relative pose are known, the at least one processor identifies the gaze-contingent region within the at least one second image. Optionally, in this regard, the at least one processor is configured to map the gaze directions onto a field of view of the at least one second image from a perspective of the second relative pose, in order to identify the gaze-contingent region within the at least one second image. The term “gaze-contingent region” refers to a region within the at least one second image where the user is gazing or focusing his/her attention. It will be appreciated that objects (or their parts) present in the gaze-contingent region are gaze-contingent objects. This means such objects are focused onto foveae of the user's eyes, and are resolved to a much greater detail as compared to remaining (non-gaze-contingent) objects (namely, objects lying outside the gaze-contingent region) present in a real-world scene that is captured in the at least one second image.

It will be appreciated that unlike prior art that suffer from inaccuracies due to poor calibration or a reliance on object locations in relation to the user, for gaze tracking purposes, the method enables in dynamically identifying the gaze-contingent region by using the (real-time) second relative pose and the gaze direction. This results in a more precise mapping of the user's gaze, even in complex or rapidly changing environments. By eliminating a need for extensive pre-calibration and using real-time data from existing components only (such as the smartphone and the eyewear apparatus), the system facilitates in reducing a latency in determining the gaze direction and the gaze-contingent region, thereby enabling quicker and responsive user interactions. The method and the system are susceptible to be employed in both static and dynamic environments without relying on predetermined object locations or any calibration, and thus can adapt with various real-world scenarios, including those with moving objects or changing environmental conditions. Furthermore, leveraging existing consumer technology (such as smartphones and eyewear apparatuses) reduces a need for specialised or expensive hardware, making the system more accessible and affordable compared to solutions that require dedicated devices or sensors. By continuously monitoring and adapting to changes in the user's gaze in real-time, the system enables in enhancing user's interaction experience within extended-reality (XR) environments.

Optionally, the step of identifying the gaze-contingent region in the at least one second image comprises:
determining a gaze point and an optical depth of the gaze point, based on the gaze directions of the user's eyes; and
identifying, in a depth map associated with the at least one second image, a set of pixels including and surrounding the gaze point and whose optical depth lies within a predetermined threshold distance from the optical depth of the gaze point, wherein the gaze-contingent region comprises the set of pixels.

The term “gaze point” refers to a location within a field of view of the user where the user's eyes are directed/focussed. In other words, the gaze point correspond to a gaze-contingent object or its part present in the real-world environment. Furthermore, the term “optical depth” refers to a distance of an object (or its part) present in the real-world environment from the user's eyes. In other words, the optical depth is indicative of how far or near the user's focus is from his/her current position. The optical depth of the gaze point is a distance from the user's eyes to a point at which the gaze directions of the user's eyes converge. The gaze point and the optical depth are well-known in the art. Optionally, when determining the gaze point, the at least one processor is configured to map a gaze direction of a first eye of the user and a gaze direction of a second eye of the user onto the field of view of the user. The first eye is one of a left eye and a right eye of the user, while the second eye is another of the left eye and the right eye. It will be appreciated that since an angle of convergence of the gaze directions of the user's eyes, an interpupillary distance (IPD) of the user's eyes, and the gaze point are already known to the at least one processor, the optical depth of the gaze point can be easily determined by the at least one processor, for example, using at least one mathematical technique. The at least one mathematical technique could be at least one of: a triangulation technique, a geometry-based technique, a trigonometry-based technique. The IPD of the user's eyes can be an average IPD. Determining the gaze point and the optical depth allows the at least one processor to track where the user is looking/gazing. Techniques for determining the gaze point and the optical depth of the gaze point depth using the gaze directions are well-known in the art.

The term “depth map” refers to a data structure comprising information pertaining to optical depths of objects (or their parts) present in the real-world environment. Optionally, the depth map is an image comprising a plurality of pixels, wherein a pixel value of each pixel indicates an optical depth of its corresponding real-world point/region within the real-world environment. The term “object” refers to a physical object or a part of the physical object present in the real-world environment. The object could be a living object (for example, such as a human, a pet, a plant, and the like) or a non-living object (for example, such as a wall, a window, a toy, a poster, a lamp, and the like). It will be appreciated that when the depth map is associated with the at least one second image, said depth map represents the optical depths of the objects from a perspective of a pose with which the at least one second image has been captured. Moreover, the at least one processor may analyse the at least one second image in a pixel-by-pixel manner, for identifying said set of pixels.

When the optical depth for the set of pixels lies within the predetermined threshold distance from the optical depth of the gaze point, it is highly likely that the pixels in said set and the gaze point correspond to a same object (or its part) in the real-world environment, and thus their respective optical depths would be considerably similar (i.e., would not have a drastic difference). Beneficially, in such a case, it may be ensured that the gaze-contingent region (comprising the set of pixels) is significantly accurately identified in the at least one second image.

Otherwise, when the optical depth for the set of pixels does not lie within the predetermined threshold distance, it may be likely that the pixels in said set and the gaze point do not correspond to a same object, and may correspond to different objects lying at different optical depths in the real-world environment. For example, in some scenarios, a given pixel of the set may correspond to a portion of a boundary of an object and a neighbouring pixel may correspond to another object which lies at a different optical depth (as compared to said object), but is represented adjacent to said object in the at least one second image. In other words, only pixels representing objects at a very similar optical distance to the gaze point would be included in the gaze-contingent region, thereby reducing visual noise, and enhancing focus of the user. Thus, the gaze-contingent region would comprise pixels that meet the aforesaid criteria of being in very close proximity to the gaze point as well as having optical depths within the predetermined threshold distance. Optionally, the predetermined threshold distance lies in a range of 5 percent to 15 percent from the optical depth of the gaze point. In an example, when the (determined) optical depth of the gaze point is 100 centimeters, the predetermined threshold distance may lie in a range of 90 centimeters to 110 centimeters (i.e., (+/−) 10 percent of the (determined) optical depth).

It will be appreciated that by determining the gaze point and its associated optical depth, and then identifying the set of pixels within the depth map, it is likely ensured that the gaze-contingent region closely aligns with where the user is actually focusing. Such an approach reduces a likelihood of including irrelevant or incorrectly identified regions in the at least one second image, leading to a precise gaze mapping. Moreover, by identifying the pixels whose optical depth is within the predetermined threshold distance, the method enables in filtering out background objects or other irrelevant elements that might otherwise be included in the gaze-contingent region. This enhances a clarity of the gaze-contingent region and minimises a visual noise, ensuring that only relevant parts of a visual scene are present in the gaze-contingent region. A reliance on the depth map for identifying the gaze-contingent region, rather than any pre-defined models or calibration processes makes the method highly adaptable to changes in the real-world environment. This ensures that the method and the system are susceptible to be employed in both static and dynamic settings, without requiring extensive recalibration or adjustment.

Optionally, the method further comprises applying a visual effect to the identified gaze-contingent region. In this regard, the term “visual effect” refers to a visual enhancement applied to the gaze-contingent region in order to highlight/emphasize it in the at least one second image. Beneficially, such visual effects provide information pertaining gaze-contingent regions in a sequence of second images more readily and accurately, especially, in a scenario where a continuous tracking of user's gaze may be required. Optionally, when applying the visual effect, the at least one processor is configured to employ at least one image processing algorithm. Image processing algorithms for applying visual effects are well-known in the art.

It will be appreciated that applying the visual effect to the gaze-contingent region helps highlight said region area within the at least one second image. This may make it easier for users or systems to discern and focus on the gaze-contingent region, improving an effectiveness of gaze-based applications. By highlighting the gaze-contingent region with visual effect, user interactions become more intuitive. For example, in augmented reality (AR) applications, visual effects can help users quickly identify points of interest or interactive elements that are relevant to their gaze, leading to a more engaging and user-friendly experience. For applications involving gaze tracking, applying visual effects aids in clearer visualisation and interpretation of gaze patterns of the user. This can be beneficial in research, usability studies, or any scenario where understanding user focus and attention is critical. Furthermore, a use of the visual effect may also provide a flexibility in how the gaze-contingent region is presented. Different effects, such as changes in colour, brightness, or an addition of virtual boundaries, can be employed depending on specific needs of an application or user preferences.

Optionally, the step of applying the visual effect comprises at least one of:
digitally superimposing a virtual boundary around the identified gaze-contingent region; and
adjusting at least one of: a brightness, a color, a sharpness, of pixels belonging to the identified gaze-contingent region.

In this regard, the virtual boundary serves as a visual indicator for the identified gaze-contingent region. In other words, the virtual boundary is indicative of a clear distinction between the gaze-contingent region and a non-gaze-contingent region within the at least one second image. Optionally, when digitally superimposing the virtual boundary, the at least one processor is configured to employ a virtual object generation algorithm. The term “virtual boundary” refers to a computer-generated boundary (namely, a digital boundary). A shape and a size of the virtual boundary conforms with a shape and a size of the identified gaze-contingent region. As the user's gaze shifts, an overlay of the virtual boundary around the identified gaze-contingent region could be adapted accordingly, in real-time or near-real time. Further, optionally, when adjusting at least one of the aforesaid parameters of the pixels belonging to the identified gaze-contingent region, the at least one processor is configured to employ at least one image processing algorithm. Such image processing algorithms are well-known in the art. It will be appreciated that such image processing algorithms enable in modifying (namely, increasing or decreasing) pixel values of said pixels, for adjusting the at least one of: the brightness, the color, the sharpness, of said pixels. It will also be appreciated that the aforesaid manner applying of the visual effect is simple, reliable, accurate, and requires less post-processing time of the at least one processor.

It will be appreciated that by digitally superimposing the virtual boundary around the gaze-contingent region, an area of interest can be quickly and easily identified. Such a virtual boundary serves as a clear visual indicator, reducing a cognitive load required to locate the gaze-contingent region within the at least one second image. This may enhance user interaction by making the area of interest more prominent and easier to discern. The virtual boundary can adapt in real-time to the user's gaze, providing a dynamic and interactive experience. This adaptability may ensure that as the user's gaze changes, visual enhancements remain relevant. Furthermore, adjusting the at least one of: the brightness, the color, the sharpness, for the gaze-contingent region also allows for better differentiation of such a region from a remainder of the at least one second image. This leads to improved visual clarity, making it easier to focus on important details and reducing visual noise from non-gaze-contingent areas. The aforesaid manner applying of the visual effect may be applicable across various fields such as augmented reality (AR), virtual reality (VR), and user interface design, where highlighting specific areas in real-time is beneficial. For example, this may be useful in diverse scenarios, including medical imaging, surveillance, and interactive media, where visual clarity and focus are crucial for effective gaze data interpretation and interaction.

Optionally, the method further comprises generating a gaze map of the real-world environment using the at least one second image. In this regard, the term “gaze map” refers to a visual representation of a pattern of the user's gaze when viewing the at least one second image. The gaze map indicates where the user is looking/gazing within the real-world environment. Optionally, when utilising the at least one second image, the gaze-contingent region within the at least one second image is highlighted, and the gaze map is generated, for example, by overlaying or digitally superimposing virtual indicators on/around the identified gaze-contingent region (as discussed earlier). Such visual indicators could, for example, be colour-coded highlights or digital graphical arrows/pointers to represent gaze-contingent regions for a sequence of second images. Beneficially, the gaze map provide information pertaining gaze-contingent regions in the sequence of second images more readily and accurately, especially, in a scenario where a continuous tracking/monitoring of the user's gaze may be required.

It will be appreciated that generating the gaze map allows for a visual representation of where the user is focusing their attention within the real-world environment. This provides a clear and intuitive way to understand gaze patterns and behaviors of the user, which can be useful for applications like user experience research or behavioral studies. The gaze map enables real-time tracking and monitoring of the user's gaze across different second images. This is beneficial for applications that require continuous attention tracking, such as interactive systems, augmented reality (AR), or virtual reality (VR) environments. By overlaying or digitally superimposing virtual indicators on the identified gaze-contingent regions, the gaze map helps to highlight key areas of interest in the environment. The gaze map provides a detailed and accurate representation of the user's gaze direction and focus points, which can improve execution of applications that depend on accurate gaze tracking. The gaze map can be used to generate quantitative data about gaze patterns, which can be analyzed to gain insights into user behavior and preferences. This is useful for research and development purposes, allowing for better decision-making and optimization based on real user interactions.

The present disclosure also relates to the system as described above. Various embodiments and variants disclosed above, with respect to the aforementioned method, apply mutatis mutandis to the system.

Optionally, in the system, the at least one processor is further operable to generate a gaze map of the real-world environment using the at least one second image.

Optionally, in the system, when determining the first relative pose, the at least one processor is further operable to identify at least one feature indicative of a pre-known shape of the eyewear apparatus, in the at least one first image, and utilise a pose of the at least one feature as represented in the at least one first image for determining the first relative pose.

Optionally, in the system, the at least one processor is further operable to determine a pose of the eyewear apparatus in the real-world environment by processing pose-tracking data, collected by a pose tracking means arranged in the eyewear apparatus,
wherein the first relative pose is determined based on the pose of the eyewear apparatus in the real-world environment.

Optionally, in the system, when identifying the gaze-contingent region in the at least one second image, the at least one processor is further operable to:
determine a gaze point and an optical depth of the gaze point, based on the gaze directions of the user's eyes; and
identify, in a depth map associated with the at least one second image, a set of pixels including and surround the gaze point and whose optical depth lies within a predetermined threshold distance from the optical depth of the gaze point, wherein the gaze-contingent region comprises the set of pixels.

Optionally, in the system, the at least one processor is further operable to apply a visual effect to the identified gaze-contingent region.

Optionally, in the system, when applying the visual effect, the at least one processor is further operable to perform at least one of:
digitally superimpose a virtual boundary around the identified gaze-contingent region; and
   adjust at least one of: a brightness, a color, a sharpness, of pixels belonging to the identified gaze-contingent region.

Optionally, in the system, the first camera and the second camera are arranged on opposite sides of a portable device.

### DETAILED DESCRIPTION OF THE DRAWINGS

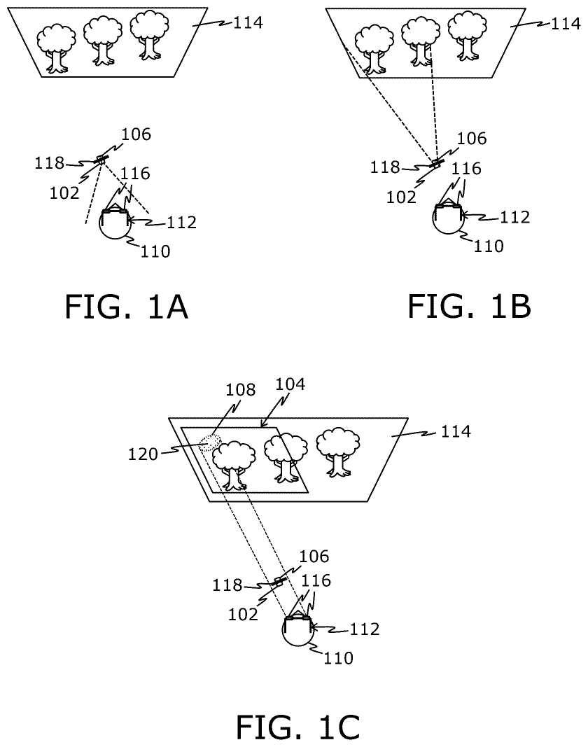

Referring to FIGS. 1A, 1B, and 1C, FIG. 1A illustrates how at least one first image is captured by a first camera 102, FIG. 1B illustrates how at least one second image (depicted as a second image 104 in FIG. 1C) is captured by a second camera 106, while FIG. 1C illustrates how a gaze-contingent region 108 (depicted using a dotted oval shape) is identified in the at least one second image 104, in accordance an embodiment of the present disclosure. With reference to FIGS. 1A-1C, a user 110 is shown to be wearing an eyewear apparatus 112 and viewing a real-world scene in a real-world environment 114. The eyewear apparatus 112 has a gaze-tracking means 116 arranged thereat. The first camera 102 and the second camera 106 are arranged on opposite sides of a portable device 118, in a manner that the first camera 102 faces the eyewear apparatus 112, while the second camera 106 faces a real-world environment 114. With reference to FIG. 1A, the first camera 102 is controlled to capture the at least one first image representing at least the eyewear apparatus 112 or its part. The at least one first image is processed to determine a first relative pose of the eyewear apparatus 112 with respect to the first camera 102. Additionally, gaze tracking data collected by the gaze-tracking means 116, is processed to determine gaze directions of user's eyes. With reference to FIG. 1B, the second camera 106 is controlled to capture the second image 104 (as shown in FIG. 1C) representing the real-world scene of the real-world environment 114. Furthermore, a second relative pose of the user's eyes with respect to the second camera 106 is determined, based on the first relative pose and a pre-known relative pose of the first camera 102 with respect to the second camera 106. With reference to FIG. 1C, the gaze-contingent region 108 is identified in the second image 104, based on the determined gaze directions and the determined second relative pose. The identified gaze-contingent region 108 is shown to have a visual effect 120 applied thereon. Moreover, optionally, a gaze map of the real-world environment 104 is generated by using the second image 104.

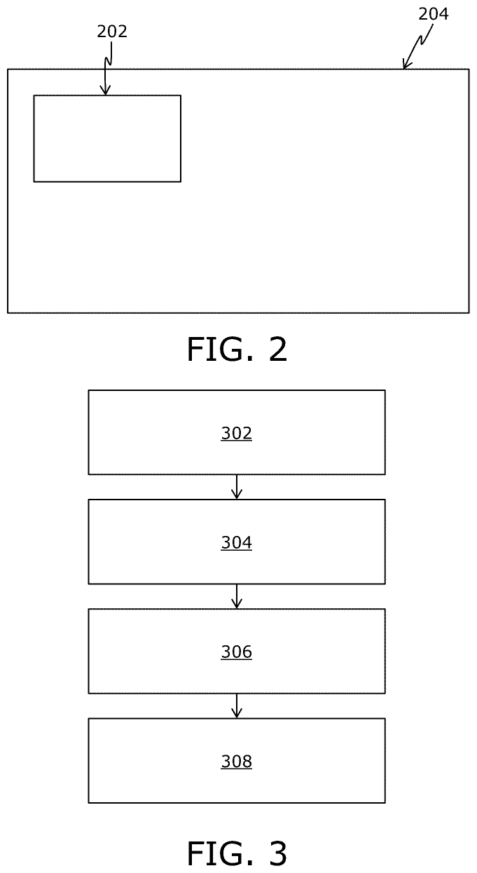

Referring to FIG. 2, illustrated is a gaze-contingent region 202 in at least one second image (for example, depicted as a second image 204) of a real-world environment, in accordance with an embodiment of the present disclosure. With reference to FIG. 2, the gaze-contingent region 202 is shown to lie towards a top-left side region of the second image 204. The second image 204 is captured by a second camera (not shown). The gaze-contingent region 202 in the second image 204 is identified, based on gaze directions of user's eyes (not shown) and a second relative pose of the user's eyes with respect to the second camera.

FIGS. 1A-1C and FIG. 2 are merely examples, which should not unduly limit the scope of the claims herein. The person skilled in the art will recognize many variations, alternatives, and modifications of embodiments of the present disclosure.

Referring to FIG. 3, illustrated are steps of a method of gaze-mapping in real-world environments, in accordance with an embodiment of the present disclosure. At step 302, a first relative pose of an eyewear apparatus with respect to a first camera is determined by processing at least one first image captured by the first camera. At step 304, gaze directions of user's eyes are determined by processing gaze-tracking data collected by a gaze-tracking means, wherein the gaze-tracking means is arranged in the eyewear apparatus. At step 306, a second relative pose of the user's eyes with respect to a second camera is determined, based on the determined first relative pose and a pre-known relative pose of the first camera with respect to the second camera, wherein the second camera is arranged to face a real-world environment. At step 308, a gaze-contingent region is identified in at least one second image captured by the second camera, based on the determined gaze directions and the determined second relative pose.

The aforementioned steps are only illustrative and other alternatives can also be provided where one or more steps are added, one or more steps are removed, or one or more steps are provided in a different sequence without departing from the scope of the claims.

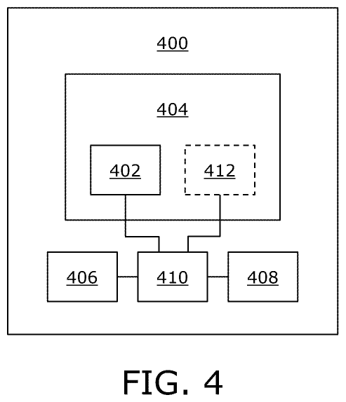

Referring to FIG. 4, illustrated is a block diagram of an architecture of a system 400 of gaze-mapping in real-world environments, in accordance with an embodiment of the present disclosure. The system 400 comprises a gaze-tracking means 402 arranged in an eyewear apparatus 404, a first camera 406, a second camera 408, and at least one processor (for example, depicted as a processor 410). The processor 410 is communicably coupled to the gaze-tracking means 402, the first camera 406, and the second camera 408. Optionally, the system 400 further comprises a pose tracking means 412 arranged in the eyewear apparatus 404. The processor 410 is optionally communicably coupled to the pose tracking means 412. The processor 410 is operable to perform various operations, as described earlier with respect to the aforementioned second aspect.

It may be understood by a person skilled in the art that FIG. 4 includes a simplified architecture of the system 400, for sake of clarity, which should not unduly limit the scope of the claims herein. It is to be understood that the specific implementation of the system 400 is provided as an example and is not to be construed as limiting it to specific numbers or types of gaze-tracking means, pose-tracking means, cameras, and processors. The person skilled in the art will recognize many variations, alternatives, and modifications of embodiments of the present disclosure.

1. A method of gaze-mapping in real-world environments, the method comprising:
determining a first relative pose of an eyewear apparatus with respect to a first camera by processing at least one first image captured by the first camera;
determining gaze directions of a user's eyes by processing gaze-tracking data collected by a gaze-tracking means, wherein the gaze-tracking means is arranged in the eyewear apparatus;
determining a second relative pose of the user's eyes with respect to a second camera based on the determined first relative pose and a pre-known relative pose of the first camera with respect to the second camera, wherein the second camera is arranged to face a real-world environment; and
identifying a gaze-contingent region in at least one second image captured by the second camera, based on the determined gaze directions and the determined second relative pose.

2. The method of claim 1, further comprising generating a gaze map of the real-world environment using the at least one second image.

3. The method of any of claim 1, wherein the step of determining the first relative pose comprises identifying at least one feature indicative of a pre-known shape of the eyewear apparatus, in the at least one first image, and utilising a pose of the at least one feature as represented in the at least one first image for determining the first relative pose.

4. The method of claim 1, further comprising determining a pose of the eyewear apparatus in the real-world environment by processing pose-tracking data, collected by a pose-tracking means arranged in the eyewear apparatus,
wherein the first relative pose is determined based on the pose of the eyewear apparatus in the real-world environment.

5. The method of claim 1, wherein the step of identifying the gaze-contingent region in the at least one second image comprises:
determining a gaze point and an optical depth of the gaze point, based on the gaze directions of the user's eyes; and
identifying, in a depth map associated with the at least one second image, a set of pixels including and surrounding the gaze point and whose optical depth lies within a predetermined threshold distance from the optical depth of the gaze point, wherein the gaze-contingent region comprises the set of pixels.

6. The method of claim 1, further comprising applying a visual effect to the identified gaze-contingent region.

7. The method of claim 6, wherein the step of applying the visual effect comprises at least one of:
digitally superimposing a virtual boundary around the identified gaze-contingent region; and
adjusting at least one of: a brightness, a colour, a sharpness, of pixels belonging to the identified gaze-contingent region.

8. The method of any of claim 1, wherein the first camera and the second camera are arranged on opposite sides of a portable device.

9. A system comprising:
a gaze-tracking means arranged in an eyewear apparatus;
a first camera arranged to face a user;
a second camera arranged to face a real-world environment surrounding the user; and
at least one processor communicably coupled to the gaze-tracking means, the first camera and the second camera, wherein the at least one processor is operable to:
determine a first relative pose of the eyewear apparatus with respect to the first camera, by processing at least one first image captured by the first camera;
determine gaze directions of the user's eyes by processing gaze-tracking data collected by the gaze-tracking means;
determine a second relative pose of the user's eyes with respect to the second camera, based on the determined first relative pose and a pre-known relative pose of the first camera with respect to the second camera;
identify a gaze-contingent region in at least one second image captured by the second camera, based on the determined gaze directions and the determined second relative pose.

10. The system of claim 9, wherein the at least one processor is further operable to generate a gaze map of the real-world environment using the at least one second image.

11. The system of claim 9, wherein when determining the first relative pose, the at least one processor is further operable to identify at least one feature indicative of a pre-known shape of the eyewear apparatus, in the at least one first image, and utilise a pose of the at least one feature as represented in the at least one first image for determining the first relative pose.

12. The system of any of claim 9, wherein the at least one processor is further operable to determine a pose of the eyewear apparatus in the real-world environment by processing pose-tracking data, collected by a pose tracking means arranged in the eyewear apparatus,
wherein the first relative pose is determined based on the pose of the eyewear apparatus in the real-world environment.

13. The system of any of claim 9, wherein when identifying the gaze-contingent region in the at least one second image, the at least one processor is further operable to:
determine a gaze point and an optical depth of the gaze point, based on the gaze directions of the user's eyes; and
identify, in a depth map associated with the at least one second image, a set of pixels including and surround the gaze point and whose optical depth lies within a predetermined threshold distance from the optical depth of the gaze point, wherein the gaze-contingent region comprises the set of pixels.

14. The system of any of claim 9, wherein the at least one processor is further operable to apply a visual effect to the identified gaze-contingent region.

15. The system of claim 14, wherein when applying the visual effect, the at least one processor is further operable to perform at least one of:
digitally superimpose a virtual boundary around the identified gaze-contingent region; and
adjust at least one of: a brightness, a colour, a sharpness, of pixels belonging to the identified gaze-contingent region.
